(19) United States
(12) Patent Application Publication
(10) Pub. No.: US 2015/0303489 A1
(43) Pub. Date: Oct. 22, 2015

(54) LIQUID ACTIVATED DEVICES POWERED BY HYDROGEL BATTERIES AND METHODS THEREFORE

(71) Applicants: James Y. WANG, (US); Qingyue CHEN, Beijing (CN); Shunichiro KUROKI, Tokyo (JP); Christopher John BUNTEL, (US); EMPIRE TECHNOLOGY DEVELOPMENT LLC, Wilmington, DE (US)

(72) Inventors: James Y. WANG, Beijing (CN); Qingyue CHEN, Beijing (CN); Shunichiro KUROKI, Tokyo (JP); Christopher John BUNTEL, Singapore (SG)

(21) Appl. No.: 14/441,468

(22) PCT Filed: Nov. 7, 2012
(86) PCT No.: PCT/CN2012/084227

§ 371 Date: May 7, 2015

(51) Int. Cl. H01M 6/32; H01M 6/04; H01M 4/04; H01M 4/48; H01M 4/60; H01M 4/583; H01M 6/50; H01M 4/38

(52) U.S. Cl. CPC H01M 6/32; H01M 6/5044; H01M 6/045; H01M 4/38; H01M 4/381; H01M 4/382; H01M 4/48; H01M 4/602; H01M 4/583; H01M 4/04; H01M 2300/0005; H01M 2300/0014

(57) ABSTRACT

Liquid detection devices and perspiration-activated materials powered by liquid-activated hydrogel batteries are disclosed. A liquid detection device and a perspiration-activated material may be powered by a liquid-activated hydrogel battery comprising hydrogel permeated with electrolyte and an anode and a cathode in contact with the hydrogel. The hydrogel may become hydrated responsive to contact with a liquid, supporting ionic communication between the anode and the cathode via the electrolyte. The ionic communication may generate a voltage operative to power the liquid detection device or the perspiration-activated material connected thereto. The liquid detection device may operate to detect a liquid in contact therewith when powered by the hydrated liquid-activated hydrogel battery and to generate a detection event responsive to detecting the liquid. The perspiration-activated material may operate to evaporate and to eliminate odor associated with perspiration in contact therewith.

### BACKGROUND

Each year, water and other liquids cause billions of dollars in damage to homes, businesses, and individuals. One culprit is water leaks, for example, from roofs, plumbing systems, hot water heaters, air conditioners, and failed liquid containers. Damages from water leaks are often very severe because the leaks commonly occur hidden from view and go undetected. Another problem is the presence of liquid or liquid vapor in frozen environments due to unintentional thawing. For example, liquid may occur in an industrial freezer due to malfunctioning freezer components or inadequate sealing of the freezer door. The liquid may damage freezer contents and may also indicate that the freezer is not maintaining a proper temperature.

Liquid sensors may be used to detect the presence of liquid in unwanted areas. However, traditional liquid sensors are battery-powered, requiring difficult or complicated battery changes in areas that are a challenge to access. As a result, the batteries for liquid detection devices are not adequately monitored and are often not changed when required. In addition, the batteries for liquid sensors are often exposed to the liquid being detected, rendering the batteries inoperative. Consequently, the liquid sensors that homes and businesses rely on are frequently non-functional when they are actually needed.

Individuals are also subject to problems caused by water and other liquids. One issue involves moisture on the skin, such as perspiration. For example, in hot weather perspiration may cause blisters and fuel fungal conditions of the skin (e.g., athlete's foot) and the growth of odor-causing bacteria. Perspiration itself does not have a distinctive odor of its own. The odor is caused by bacteria on the skin that ingest the perspiration and excrete waste that has a strong odor. In colder temperatures, moisture pulls heat away from skin about twenty-three times faster than air, which may lead to dangerously low skin temperatures. Traditional clothing and treatment options, such as conventional footwear inserts and anti-bacterial/anti-fungal medications, are inconvenient and do not adequately solve the multiple problems associated with moisture on the skin.

### SUMMARY

This disclosure is not limited to the particular systems, devices and methods described, as these may vary. The terminology used in the description is for the purpose of describing the particular versions or embodiments only, and is not intended to limit the scope.

In one embodiment, a liquid detection device may comprise at least one liquid-activated hydrogel battery and at least one circuit in operative communication with the at least one liquid-activated hydrogel battery. The at least one liquid-activated hydrogel battery may be configured to generate an electric current responsive to contact with a liquid. The at least one liquid-activated hydrogel battery may comprise at least one hydrogel comprising at least one hydrophilic polymer and at least one electrolyte. The at least one liquid-activated hydrogel battery may further comprise at least one anode and at least one cathode in contact with the at least one hydrogel. The at least one electrolyte may be configured to support ionic communication between the at least one anode and the at least one cathode responsive to the hydrogel being hydrated with the liquid. In addition, the at least one electrolyte may be configured to not support the ionic communication responsive to the hydrogel being dehydrated by an effective absence of the liquid. The ionic communication may operate to generate an electric current for the at least one liquid-activated hydrogel battery. The at least one circuit may be energized by the electric current and a detection event may be initiated responsive to the at least one circuit being energized.

In one embodiment, a method of preparing a liquid detection device may comprise providing at least one liquid-activated hydrogel battery and arranging at least one circuit in operative communication with the at least one liquid-activated hydrogel battery. The at least one liquid-activated hydrogel battery may be configured to generate an electric current responsive to contact with a liquid. The at least one liquid-activated hydrogel battery may comprise at least one hydrogel comprising at least one hydrophilic polymer and at least one electrolyte. The at least one liquid-activated hydrogel battery may further comprise at least one anode and at least one cathode in contact with the at least one hydrogel. The at least one electrolyte may be configured to support ionic communication between the at least one anode and the at least one cathode responsive to the hydrogel being hydrated with the liquid. The at least one electrolyte may be configured to not support the ionic communication responsive to the hydrogel being dehydrated by an effective absence of the liquid. The ionic communication may operate to generate an electric current for the at least one liquid-activated hydrogel battery. The at least one circuit may be energized responsive to the electric current and a detection event may be initiated responsive to the at least one circuit being energized.

In one embodiment, a method of detecting liquid using at least one liquid detection device may comprise providing the at least one liquid detection device comprising at least one liquid-activated hydrogel battery and at least one circuit in operable communication with the at least one liquid-activated hydrogel battery. The at least one liquid-activated hydrogel battery may be configured to generate an electric current responsive to contact with a liquid. The at least one liquid-activated hydrogel battery may comprise at least one hydrogel comprising at least one hydrophilic polymer and at least one electrolyte. The at least one liquid-activated hydrogel battery may further comprise at least one anode and at least one cathode in contact with the at least one hydrogel. The at least one electrolyte may be configured to support ionic communication between the at least one anode and the at least one cathode responsive to the hydrogel being hydrated with the liquid. The at least one electrolyte may be configured to not support the ionic communication responsive to the hydrogel being dehydrated by an effective absence of the liquid. The ionic communication may be operative to generate an electric current for the at least one liquid-activated hydrogel battery. The at least one circuit may be energized by the electric current and a detection event may be initiated responsive to the at least one circuit being energized. The method may further comprise exposing the at least one liquid detection device to liquid such that the liquid hydrates the at least one hydrogel of the at least one liquid-activated hydrogel battery.

In one embodiment, a method of detecting a level of a liquid using a plurality of liquid detection devices may comprise providing a plurality of liquid detection devices arranged at a plurality of heights configured to indicate a level of the liquid. Each liquid detection device may comprise at least one liquid-activated hydrogel battery configured to generate an electric current responsive to contact with a liquid and at least one circuit in operative communication with the at least one liquid-activated hydrogel battery. The at least one liquid-activated hydrogel battery may comprise at least one hydrogel comprising at least one hydrophilic polymer and at least one electrolyte. The at least one liquid-activated hydrogel battery may further comprise at least one anode and at least one cathode in contact with the at least one hydrogel. The at least one electrolyte may be configured to support ionic communication between the at least one anode and the at least one cathode responsive to the hydrogel being hydrated with the liquid. The at least one electrolyte may be configured to not support the ionic communication responsive to the hydrogel being dehydrated by an effective absence of the liquid. The ionic communication may be operative to generate an electric current for the at least one liquid-activated hydrogel battery. The at least one circuit may be energized by the electric current and a detection event may be initiated responsive to the at least one circuit being energized. The method may further comprise exposing the plurality of liquid detection devices to the liquid such that the liquid hydrates the at least one hydrogel of the at least one liquid-activated hydrogel battery of at least one of the plurality of liquid detection devices. The level of the liquid may be determined based on a height of a highest liquid detection device associated with a detection event.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1A depicts an illustrative liquid-activated hydrogel battery comprising a hydrogel in a hydrated state according to some embodiments.

FIG. 1B depicts an illustrative liquid-activated hydrogel battery comprising a hydrogel in a dehydrated state according to some embodiments.

FIG. 2 depicts an illustrative liquid detection device according to some embodiments.

FIG. 3 depicts another illustrative liquid detection device according to some embodiments.

FIG. 4 depicts a further illustrative liquid detection device according to some embodiments.

FIG. 5 depicts a still further illustrative liquid detection device according to some embodiments.

FIG. 6 depicts an illustrative perspiration-activated material according to some embodiments.

FIG. 7 depicts another illustrative perspiration-activated material according to some embodiments.

FIG. 8 depicts a flow diagram for an illustrative method of manufacturing a liquid detection device according to some embodiments.

FIG. 9 depicts a flow diagram for an illustrative method of detecting a liquid using a liquid detection device according to some embodiments.

FIG. 10 depicts an illustrative method of detecting a level of a liquid using a plurality of liquid detection devices.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is not limited to the particular systems, devices and methods described, as these may vary. The terminology used in the description is for the purpose of describing the particular versions or embodiments only, and is not intended to limit the scope.

The present disclosure is directed to liquid detection devices configured to be powered, at least in part, by one or more liquid activated hydrogel batteries (described in more detail below). In this manner, a liquid detection device configured according to embodiments provided herein may be activated in the presence of liquid and may be dormant otherwise. This characteristic allows, among other things, for conservation of power and minimization of maintenance associated with the liquid detection device. Illustrative and non-restrictive examples of liquid detection devices include flood sensors, plumbing and roof leak sensors, and frozen environment thaw sensors.

The present disclosure is additionally directed to perspiration-activated materials that may be powered, at least in part, by a liquid-activated hydrogel battery. Perspiration may contact the liquid-activated hydrogel battery, for example, in clothing or a footwear insert, such that the liquid-activated battery becomes active. The active liquid-activated hydrogel battery may operate, for instance, to provide power to facilitate the removal of the perspiration (e.g., through evaporation) or to minimize an odor associated with the perspiration.

The liquid-activated battery may comprise a hydrogel-forming hydrophilic polymer permeated with an electrolyte. An anode and a cathode are arranged in contact with the hydrogel to complete a power circuit. When the hydrogel-forming polymer is hydrated, ionic communication occurs between the anode and the cathode via the electrolyte within the hydrated hydrogel. The hydrogel is hydrated when it is in contact with an effective amount of liquid, for example, water. This may correspond to partial or complete hydration of the hydrogel, depending upon characteristics of the hydrogel. Conversely, the hydrogel is dehydrated when there is an effective absence of liquid.

The following terms shall have, for the purposes of this application, the respective meanings set forth below.

“Liquid-activated” refers to an element or system being active responsive to exposure to a liquid. For example, a water-activated battery operates to generate a current responsive to exposure to water and is inactive when it is not exposed to water. In general, a liquid-activated system will require an effective amount of the liquid to operate, wherein an effective amount is the amount required to activate the system and to maintain functionality. Alternatively, a liquid-activated system will be inactive responsive to an effective absence of the liquid, wherein an effective absence is the amount of the liquid below which the system will not operate. For clarity, the activation may be due to a single exposure or through repeated or continuous exposure. It is also contemplated that hydration in some embodiments may be achieved through exposure to vapor alone or in combination with liquid.

“Hydrogel” refers to a gel-like material formed by a class of polymer materials that can absorb liquid without dissolving. Hydrogels generally comprise a network of cross-linked hydrophilic polymers, which, in general, are polymers containing polar or charged functional groups that make them soluble in water. Illustrative hydrophilic polymers include polymethacrylate, polyacrylate, polymethacrylamide, polyacrylamide, polyvinyl alcohol, polyvinyl acetate, cellulose or modified cellulose, collagen or modified collagen, polysaccharide, modified polysaccharide, polynucleotide, polyhydroxyethyl methacrylate (pHEMA), polyelectrolyte, or combinations thereof. Certain hydrogels may incorporate other solid or liquid material, such as antimicrobial medicines, vitamins, and electrolytes.

A “liquid-activated hydrogel battery” refers to a battery that is operative to provide power to an electronic device, circuit, and/or element responsive to contacting an effective amount of a liquid. A liquid-activated hydrogel battery may comprise a hydrogel-forming hydrophilic polymer permeated with an electrolyte. An anode and a cathode may be arranged in contact with the hydrogel to complete a power circuit. When the hydrogel-forming polymer is hydrated, ionic communication may occur between the anode and the cathode via the electrolyte within the hydrated hydrogel. The hydrogel may be hydrated when it is in contact with an effective amount of liquid, for example, water. This may correspond to partial or complete hydration of the hydrogel, depending upon characteristics of the hydrogel. Conversely, the hydrogel is dehydrated when there is an effective absence of liquid.

“Hydrated” as used herein with reference to a hydrogel, refers to a state wherein the hydrogel contains a liquid, such as water, in an effective amount for allowing ionic communication to occur between an anode and a cathode in contact with the hydrogel. A hydrogel is in a hydrated state when it contains an effective amount of water or other liquid, and such an effective amount may result in either partial or complete hydration. An effective amount of liquid is dependent upon certain factors, such as the composition and/or function of the hydrogel. Hydration may occur acutely or over time in response to contact with liquid or vapor forms. In the alternative, an effective absence of liquid occurs when there is not enough liquid in the hydrogel to support ionic communication between the anode and the cathode.

“Dehydrated” as used herein with reference to a hydrogel refers to a state wherein there is an effective absence of liquid, such as water, in the hydrogel, such that ionic communication does not occur between an anode and a cathode in contact with the hydrogel. An effective absence of liquid is dependent upon certain factors, such as the composition and/or function of the hydrogel, and may be a partial absence of liquid or a complete absence of liquid.

“Ionic communication” refers to the transfer of ions between two or more elements. For example, in a battery, ionic communication comprises the transmission of ions between anode and cathode electrodes within an electrolyte. Ionic communication between the anode and the cathode operates to generate a voltage when the power circuit of the liquid-activated hydrogel battery is closed, for example, when the liquid-activated hydrogel battery is connected to an electronic device. In this manner, the liquid-activated hydrogel battery may operate to provide a voltage to power an electronic device when the hydrogel is hydrated.

A “liquid detection device” refers to a device configured to detect the presence of one or more liquids. For example, a liquid detection device may be configured as a sensor operative to detect the presence of water. A liquid detection device may be powered in whole or in part by a liquid-activated hydrogel battery. In this manner, the liquid-activated hydrogel battery may power the liquid detection device responsive to contacting an effective amount of liquid and, in turn, the liquid detection device may operate to detect the presence of the liquid.

A “detection event” refers to an action that is triggered responsive to the detection of a liquid, for instance, by a liquid detection device. A detection event may be configured to serve one or more purposes, such as alerting individuals about the presence of a liquid and/or taking steps to prevent more liquid from entering an affected area. Examples of detection events include the transmission of a signal, the sounding of an alarm, the closing of a source of a liquid, or the powering off of an electronic device.

A “detection event device” refers to a device that operates to carry out a detection event. For example, the detection event device may be an alarm device configured to generate an alarm detection event. The detection event device may be a component of a liquid detection device or may be in communication with a liquid detection device. For instance, a liquid detection device may operate to transmit a signal to a remote detection event device configured to initiate a detection event.

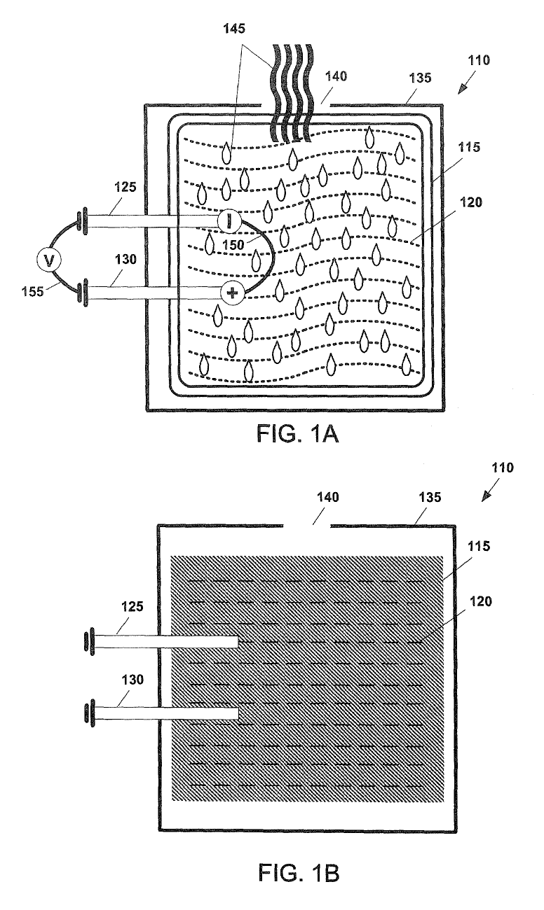

FIG. 1A depicts an illustrative liquid-activated hydrogel battery comprising a hydrogel in a hydrated state according to some embodiments. As shown in FIG. 1A, a liquid-activated hydrogel battery 110 comprises an enclosing structure 135 enveloping a hydrogel 115 permeated with an electrolyte 120. The electrolyte 120 is depicted as a series of dashed lines for illustrative purposes only. Those having ordinary skill in the art will recognize that the electrolyte will likely not be arranged in uniform rows as depicted. A cathode 125 and an anode 130 are in contact with the hydrogel 115 and the electrolyte 120 permeating the hydrogel 115.

Although one hydrogel, electrolyte, anode, and cathode have been used in certain examples herein, embodiments are not so limited, as any number and combination of hydrogels, electrolytes, anodes, and cathodes are contemplated herein.

The enclosing structure 135 may comprise a battery case or an enclosing surface of an apparatus housing the liquid-activated hydrogel battery 110, such as an electronic device powered by the liquid-activated hydrogel battery 110. For example, the enclosing structure 135 may be made of a porous material or a water permeable material. In some embodiments, the enclosing structure 135 comprises a water permeable membrane. Thus, the enclosing structure 135 needs not be a bulky physical structure, but may comprise a thin flexible water permeable membrane allowing water to pass in and out of the liquid-activated hydrogel battery 110 and/or an apparatus housing the liquid-activated hydrogel battery.

The enclosing structure 135 may have one or more openings 140 that allow a liquid 145 to enter the battery and hydrate the hydrogel 115 such that the hydrogel enters a hydrated state. For example, liquid may enter the enclosing structure 135 when the liquid-activated hydrogel battery 110 or an apparatus enclosing the liquid-activated hydrogel battery is exposed to the liquid. In the hydrated state, the hydrogel 115 is permeated with liquid such that the hydrogel 115 supports ionic communication 150 between the cathode 125 and the anode 130 through the electrolyte. For example, in the hydrated state, the hydrogel 115 and/or electrolyte 120 is fluid enough to allow for the movement of ions necessary for the ionic communication 150. In some embodiments, liquid flow is permitted into and out of the hydrogel. When the hydrogel is being hydrated, the water inflow is greater than the outflow. When the hydrogel is being dehydrated, the water outflow is greater than the inflow. In some instances, equilibrium may be achieved. In such instances, the hydrogel may be effectively hydrated or effectively dehydrated, depending upon the amount of liquid in the hydrogel at equilibrium.

The electrolyte 120 may be comprised of various forms, including gels, pastes, solids, and liquids. When the hydrogel 115 is in the hydrated phase, the electrolyte 120 may be in solution, in an aqueous phase, a gel-like phase, or some combination thereof. When the hydrogel 115 is in the dehydrated phase, the electrolyte 120 may be in a solid or semi-solid phase, such as being a single solid mass or collection of solid particles. For example, if the electrolyte 120 comprises a salt, the electrolyte may comprise an aqueous salt solution when the hydrogel 115 is in the hydrated state and may comprise solid or substantially solid salt particles when the hydrogel is in the dehydrated state. The hydrogel 115 may be formed to conform to the size and shape required for the battery and to serve as a substrate for a chemical reaction adequate to generate sufficient voltage or current ranges. The formed hydrogel 115 may move between the hydrated state and the dehydrated state repeatedly, being dried out and then saturated again as required.

The exact nature of the ionic communication 150 depends on, among other things, the materials used for the cathode 125, the anode 130, and the electrolyte 120. For example, the liquid-activated hydrogel battery 110 may comprise a copper cathode 125, a zinc anode 130, and an acid, such as sulfuric acid, as the electrolyte 120, and the ionic communication 150 may comprise at least positive zinc ions. Once the hydrogel 115 is in the hydrated state, ionic communication 150 may occur according to principles of battery operation known to those having ordinary skill in the art.

According to some embodiments, the total energy capacity of the liquid-activated hydrogel battery 110 may be proportional to the amount of the anode. During operation of the liquid-activated hydrogel battery 110, the cathode may not be consumed. However, the bigger the cathode, the higher the current the liquid-activated hydrogel battery 110 may be able to handle. In a non-limiting example, the practical capacity of a zinc anode may be about 470 Wh/kg. As such, for a liquid-activated hydrogel battery 110 running at about 0.9 V/0.5 mA for about 1000 hours, the total zinc required may be about 1 g according to the following: 0.9 V×0.5 mA=0.45 mW; for 1000 hours, the number of mWh is about 450 mWh; 450 mWh/470 Wh=about 10⁻³ kg zinc=about 1 g zinc.

The ionic communication 150 may operate to generate a voltage 155 energizing a circuit (e.g., a very-large-scale integration (VLSI) circuit) of an electronic device associated with the liquid-activated hydrogel battery 110. In an embodiment, the voltage 155 generated by the liquid-activated hydrogel battery 110 when the hydrogel is in the hydrated state is at least about 0.9 V. In another embodiment, the voltage 155 may be from about 0.9 V to about 3.0 V. The voltage 155 may be generated according to principles of battery operation known to those having ordinary skill in the art.

In an embodiment, multiple parallel anode 130-cathode 125 connections may increase the current. In another embodiment, multiple serial anode 130-cathode 125 connections may increase the voltage 155 generated by the liquid-activated hydrogel battery 110. According to some embodiments, a liquid-activated hydrogel battery 110 may comprise multiple anodes 130 and/or multiple cathodes 125 arranged in series, parallel, and combinations thereof.

FIG. 1B depicts an illustrative liquid-activated hydrogel battery comprising a hydrogel in a dehydrated state according to some embodiments. As shown in FIG. 1B, the hydrogel 115 is not saturated with liquid and is in a dehydrated state. For example, the liquid may have been drained from the enclosing structure 135 through the openings 140 and/or the liquid may have evaporated from the enclosing structure and the water vapor escaped through one or more of the openings. The nature of and the time required for the removal of water from the enclosing structure 135 may depend on various factors, including, without limitation, the components and thickness of the hydrogel 115, the electrolyte 120, the structure of the enclosing structure and the number of openings 140, the structure of an apparatus housing the liquid-activated hydrogel battery 110, and the level of saturation of the hydrogel. When the hydrogel 115 is in the dehydrated state, ionic communication does not occur between the anode 130 and the cathode 125. As such, the liquid-activated hydrogel battery 110 does not generate a voltage. In the dehydrated state, the hydrogel 115 and/or electrolyte 120 is dry (e.g., free or substantially free of liquid) and is not fluid enough to allow for the movement of ions necessary for ionic communication 150.

The hydrogel 115 may be configured according to some embodiments to consist of one or more hydrophilic polymers, including, without limitation, polymethacrylate, polyacrylate, polymethacrylamide, polyacrylamide, polyvinyl alcohol, polyvinyl acetate, cellulose or modified cellulose, collagen or modified collagen, polysaccharide, modified polysaccharide, polynucleotide, polyhydroxyethyl methacrylate (pHEMA), polyelectrolyte, and combinations thereof. A polyelectrolyte may include polymers comprising a repeating unit bearing an electrolyte group. Non-limiting examples include polyacrylic acid/salt, polymethacrylic acid/salt, polystyrene sulphonic acid/salt, ionic polypeptides, ionic polysaccharides, and combinations thereof.

Some embodiments provide that the anode 130 may consist of an anode material comprising zinc, magnesium, aluminum, calcium, lithium, conducting polymers, iron, nickel, metal oxides, or combinations thereof. The cathode 125 may be configured according to some embodiments to consist of a cathode material comprising one or more of copper, carbon, silver, metal oxides, conducting polymers, carbon, carbon nanotubes, graphite, graphene, and combinations thereof.

The electrolyte 120 may consist of certain classes of materials depending on various factors, such as the type of hydrogel, anode material, cathode material, operating environment, and expected liquid saturation levels. Classes of materials that may be used for the electrolyte include, without limitation, salts, acids, and bases.

According to some embodiments, the electrolyte 120 may include a salt comprising ammonium sulfate, ammonium hydrogen sulfate, ammonium nitrate, ammonium phosphate, ammonium hydrogen phosphate, ammonium dihydrogen phosphate, ammonium chloride, sodium hydrogen sulfate, potassium hydrogen sulfate, sodium dihydrogen phosphate, potassium dihydrogen phosphate, sodium phosphate, potassium phosphate, sodium carbonate, potassium carbonate, and combinations thereof.

Some embodiments provide that the electrolyte 120 may include an acid comprising citric acid, glutaric acid, lactic acid, boric acid, acetic acid, propionic acid, phosphoric acid, phosphorous acid, hydrochloric acid, sulfuric acid, amino acids, sulfonic acids, and combinations thereof.

The electrolyte 120 may be configured according to some embodiments to include a base comprising sodium hydroxide, potassium hydroxide, calcium hydroxide, lithium hydroxide, and combinations thereof.

In an embodiment, the liquid used to hydrate the hydrogel 115 may comprise one or more forms of water. For example, the water may consist of one or more of the following: ground water, industrial water effluent, drinking water, rain water, brackish water, surface water, mineral water, salt water, substantially fresh water, distilled water, deionized water, and combinations thereof. In some embodiments, the hydrogel 115 may be hydrated with liquids including, without limitation, perspiration, blood, milk, and organic liquids (e.g., solvents).

As described in relation to FIG. 1A and FIG. 1B, the liquid-activated hydrogel battery may alternate between an operative state (e.g., the hydrated state) and a dormant state (e.g., the dehydrated state). Movement between the hydrated and dehydrated states may be a function of whether the hydrogel is in contact with an effective amount of liquid. The time required to move between the hydrated state and the dehydrated state, and vice versa, may depend on various factors, including the structure and materials of the liquid-activated hydrogel battery components. For example, certain hydrogels associated with certain hydrophilic polymers may require a different amount of liquid and/or a different length of exposure to liquid to enter the hydrated state. In addition, physical dimensions, such as the size and thickness of a hydrogel, may be a factor. In another example, each electrolyte material may support ionic communication at a different level of hydrogel saturation. One difference between the hydrated state and the dehydrated state of a hydrogel is that ionic communication between the anode and the cathode may occur in the hydrated state and is prevented in the dehydrated state.

In an embodiment, the time to move between the hydrated state and the dehydrated state, and vice versa, may take about 1 second to about 5 minutes. In another embodiment, the time required to move between states may take about 1 second to about 30 seconds. In yet another embodiment, the time required to move between states may take about 20 seconds to about 1 minute. In a further embodiment, the time required to move between states may take about 1 minute to about 3 minutes. In an embodiment, the hydrogel may comprise pHEMA having a thickness of about 1 mm, wherein the time to move between states may take about 1 minute to about 3 minutes.

Although only one liquid-activated hydrogel battery 110 is depicted in FIGS. 1A and 1B, embodiments are not so limited, as a plurality of batteries is also contemplated herein. In an embodiment, the plurality of batteries may comprise a plurality of liquid-activated hydrogel batteries. In another embodiment, the plurality of batteries may comprise one or more liquid-activated hydrogel batteries and one or more traditional batteries.

The plurality of batteries may be connected in series, in parallel, and in combinations thereof. An example provides that two or more of the plurality of batteries may be connected in series, for instance, to increase the available voltage produced by the plurality batteries. In another example, two or more of the plurality of batteries may be connected in parallel, for instance, to increase the available current provided by the plurality batteries.

Some embodiments provide that one or more liquid-activated batteries may be connected to one or more traditional batteries in series, parallel, or combinations thereof. In an embodiment, an active liquid-activated hydrogel battery may operate to close a circuit connected to a traditional battery acting as a power supply for one or more electronic devices. In this manner, the liquid-activated hydrogel battery may operate similar to a liquid-activated on/off switch, allowing the traditional (and potentially higher voltage) battery to operate when the liquid-activated hydrogel battery is sufficiently hydrated.

According to some embodiments, at least a portion of the plurality of batteries may be connected in series, parallel, both series and parallel, and combinations thereof. In a non-limiting example, a first portion of the plurality of batteries may be connected in series and a second portion of the plurality of batteries may be connected in parallel. In another non-limiting example, the first portion may be connected to the second portion.

In an embodiment, the liquid-activated hydrogel battery may operate in wet or substantially wet environments. The liquid-activated hydrogel battery is especially well-suited for applications that cycle from wet to dry. The liquid-activated hydrogel battery may form a battery circuit and provide power to a battery-powered electronic device. As such, a liquid-activated hydrogel battery configured according to some embodiments may operate as a power supply for an electronic device developed to be exposed to a wet or substantially wet environment. In this manner, the battery may be activated when exposed to a wet or substantially wet environment and may become dormant when not needed. Such a configuration may operate to, among other functions, conserve resources and energy, and to increase the life of the liquid-activated hydrogel battery and the electronic devices powered by the liquid-activated hydrogel battery.

According to some embodiments, a liquid-activated hydrogel battery may be connected as a power supply to one or more electronic devices including, without limitation, a sensor, an actuator, a processor, a switch, a light source, an alarm, a receiver, a transceiver, a transponder, a radio-frequency identification device, contact lenses associated with power displays and/or circuits, a liquid detection device, perspiration-activated materials, and combinations thereof. As such, a liquid-activated hydrogel battery may operate to provide power in various applications, for example, for electronic devices embedded in clothing exposed to liquids and radio-frequency identification (RFID) devices used to track underwater assets, such as fish in an aquarium and equipment used by offshore drilling companies.

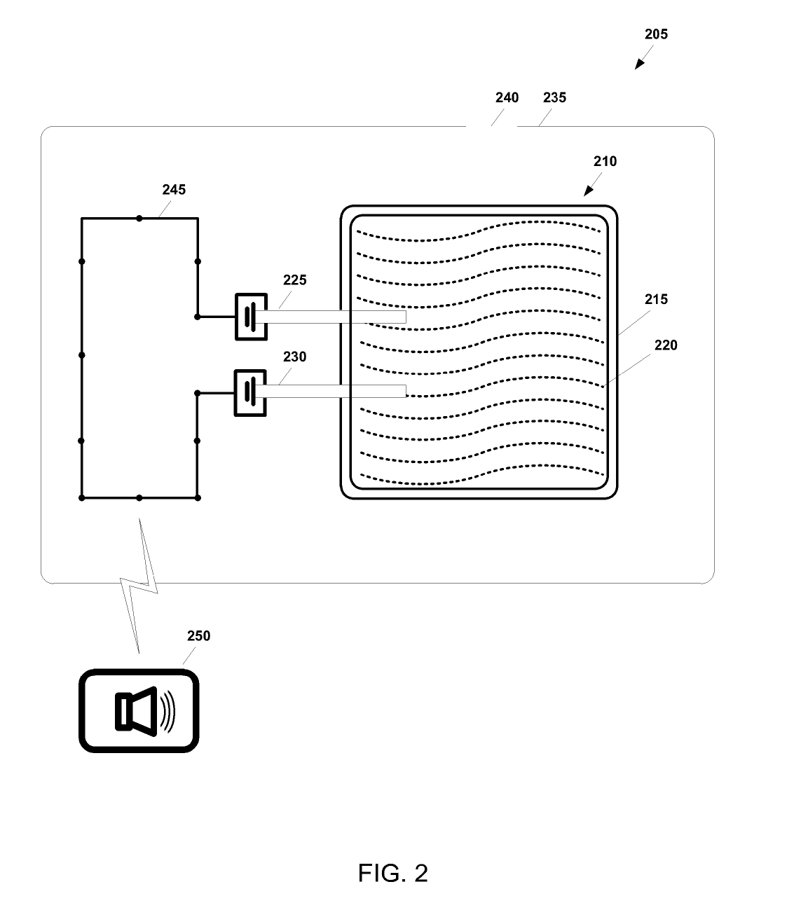

One beneficial application of a liquid-activated hydrogel battery configured according to some embodiments described herein is as a liquid-activated power supply in a liquid detection device. FIG. 2 depicts an illustrative liquid detection device according to some embodiments. As shown in FIG. 2, the liquid detection device 205 may comprise an outer wall 235 enclosing a liquid-activated hydrogel battery 210 in operative communication with a circuit 245. Circuit 245 may be enclosed within the outer wall 235, as shown in FIG. 2, or may be in a separate housing while still electrically coupled to the liquid-activated hydrogel battery 210. The liquid detection device 205 may use the liquid-activated hydrogel battery 210, either in whole or in part, as a power supply. The liquid-activated hydrogel battery 210 may comprise a hydrogel 215 permeated with an electrolyte 220. The electrolyte 220 is depicted as a series of dashed lines for illustrative purposes only. Those having ordinary skill in the art will recognize that the electrolyte will likely not be arranged in uniform rows as depicted. A cathode 225 and an anode 230 may be in contact with the hydrogel 215 and with the electrolyte 220 contained within the hydrogel.

The liquid may enter the liquid detection device 205 and contact the battery 210, saturating (e.g., hydrating) the hydrogel 215 and, therefore, the electrolyte 220. When the hydrogel is effectively hydrated with the liquid, the hydrogel is in a state that supports a flow of ions between the anode 230 and cathode 225 via the electrolyte 220. The flow of ions between the anode 230 and the cathode 225 may operate to generate a voltage for the liquid-activated hydrogel battery 210. The liquid-activated hydrogel battery 210 may power some or all of the liquid detection device 205 with the voltage generated due to the flow of ions between the anode 230 and the cathode 225. The voltage may generate an electric current that energizes the circuit 245.

The circuit 245 may be in communication with a detection event device 250 configured to initiate a detection event responsive to the circuit 245 being energized. In an embodiment, the detection event device 250 may be electrically coupled to the circuit 245. In this embodiment, the detection event device 250 may be contained at least partially within the liquid detection device 205. The energized circuit 245 may power, either in whole or in part, the detection event device 250 such that the detection event device initiates the detection event. In another embodiment, the circuit 245 may be connected to a signal transmitting element (not shown) that is communicatively connected to the detection event device 250. For example, the signal transmitting element may comprise a signal transmitter, a transponder, or a transceiver. In this embodiment, the signal transmitting element may operate to transmit one or more signals to the detection event device 250 that indicates that liquid has been detected. The signal may operate to trigger the detection event device 250 to initiate the detection event. In this embodiment, the detection event device 250 may be located external to the liquid detection device 205.

The liquid detection device 205 may be configured to detect the presence of one or more liquids. Unlike traditional liquid sensors, the liquid detection device 205 is not powered continuously in the absence of liquid, for instance, draining the power source (e.g., one or more traditional batteries) until the power source becomes inoperative and is no longer able to power the device. The liquid detection device 205 may be powered in the presence of liquid sufficient to hydrate the hydrogel 215 of the liquid-activated hydrogel battery 210 (the hydrogel is “hydrated”) and may not be powered in the absence of liquid sufficient to hydrate the hydrogel of the liquid-activated hydrogel battery (the hydrogel is “dehydrated”). In this manner, the liquid detection device 205 may be powered and operative in the presence of one or more liquids that the liquid detection device is configured to detect and may be inactive otherwise.

According to some embodiments, the detection event device 245 may comprise one or more of the following: an actuator, an alarm device, a switch, a signal transmitter, a transponder, a receiver, a transceiver, a radio-frequency identification device, and combinations thereof.

Some embodiments provide that the detection event may comprise one or more of the following: an alarm, actuating a motor or control device, closing a source of one or more liquids, powering off an electronic device, powering on an electronic device, generating and transmitting a signal, generating a visible signal, and combinations thereof.

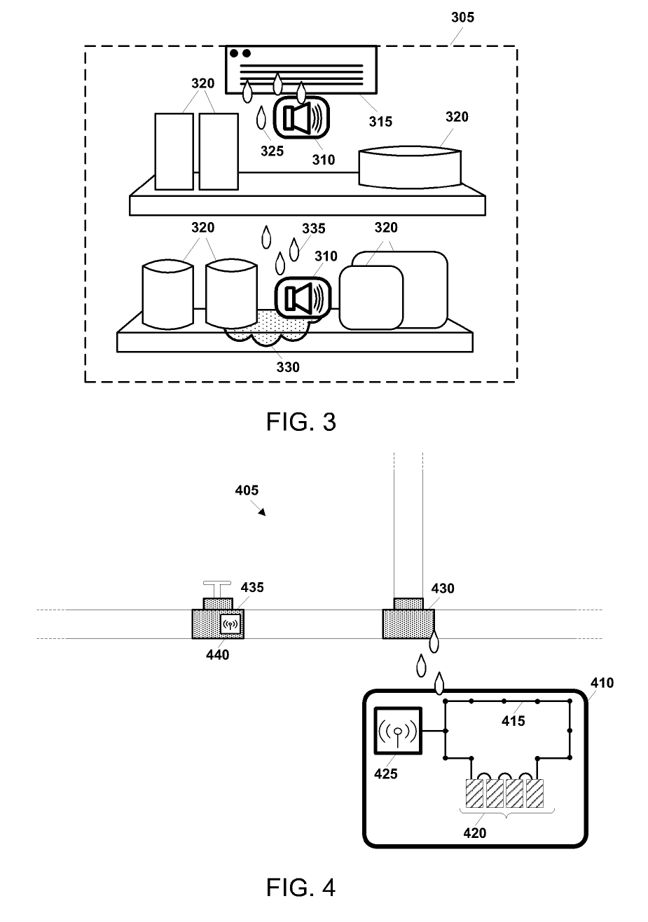

FIG. 3 depicts another illustrative liquid detection device according to some embodiments. As shown in FIG. 3, liquid detection devices 310 are arranged within a freezer 305 housing contents 320 that are intended to be maintained within a certain temperature range within the freezer (e.g., between about −5° C. and about 5° C.). For example, the contents 320 may comprise one or more of the following: food, beverages, drugs, biological specimens, chemicals, frozen liquids, semi-frozen liquids, and combinations thereof. The liquid detection devices 310 may be arranged to detect liquid within the freezer. For instance, a liquid detection device 310 may detect liquid resulting from a faulty freezer component 315, such as a failed compressor or cracked or leaking refrigerant line.

In another example, a liquid detection device 310 may be arranged to detect thawing of a liquid in a frozen state 330, 335. The thawing liquid 330 may be from freezer contents 320 thawing out due to an elevated temperature condition (e.g., sustained temperatures at or about 0° C., above about 5° C., or ranges therebetween) within the freezer 305. The thawing liquid 335 may also result from melting ice formed on the inside walls of the freezer that is thawing out due to an elevated temperature condition within the freezer. The liquid detection device 310 may also be responsive to elevated humidity levels within the freezer, which can lead to unacceptable levels of frost, requiring frequent defrosting and undesirable downtime. In an embodiment, the liquid detection devices 310 may be arranged such that liquid resulting from thawing of liquid in the frozen state 330, 335 hydrates the hydrogel of a liquid-activated hydrogel battery configured to power the liquid detection device 310 exposed to the liquid.

In some embodiments, one or more liquid detection devices are placed within the freezer at appropriate locations, for example at or near the freezer contents, and/or at, near or in the path to a drain or low point in the freezer. In some embodiments, one or more liquid detection devices can be placed directly on or within the contents. For example, a liquid detection device could be placed on a container placed in the freezer. In this manner, the device would stay with the container, even when removed, and function not only as a liquid detector for undesirable thawing in the freezer, but also as an indicator of desirable thawing outside of the freezer.

The hydrated liquid-activated hydrogel battery may operate to power the liquid detection device 310 to initiate a liquid detection event. For example, an alarm device may be connected to a circuit arranged within the liquid detection device 310 that is energized by the hydrated liquid-activated hydrogel battery. The alarm device may operate to annunciate an alarm communicating that the freezer 305 is not operating within the proper temperature range or that there is a malfunction with one or more freezer components 315. Annunciating an alarm is not limited to an audible or visual alarm, but may also take the form of generating and sending a signal to another device and/or issuing commands to or via a computer controlled operating system.

FIG. 4 depicts a further illustrative liquid detection device according to some embodiments. As shown in FIG. 4, a liquid detection device 410 is operative to detect a plumbing leak within a plumbing system 405. The plumbing system 405 comprises a valve 435 configured to shut off a supply of water to the pipes connected by a joint 430. The liquid detection device 410 is placed adjacent to the joint 430, positioned such that liquid resulting from a leak in the joint 430 may hydrate one or more hydrogels associated with a plurality of liquid-activated hydrogel batteries 420 providing power to the liquid detection device 410. This position may be on the joint, on the pipe, or remote from the pipe at a location susceptible to contact by dripping or leaking liquid. The plurality of liquid-activated hydrogel batteries 420 are connected in series and are operatively coupled to a circuit 415. The circuit 415 is connected to a wireless signal transmitter 425.

Water from a leaking joint 430 may enter the liquid detection device 410, for example, through an opening or a permeable membrane. The water inside the liquid detection device 410 may hydrate the plurality of liquid-activated hydrogel batteries 420 such that the plurality of liquid-activated hydrogel batteries generate a voltage and energize the circuit 415. The energized circuit 415 may power the wireless signal transmitter 425, which is configured to transmit a signal to a wireless receiver 440 associated with the valve 435. The signal received by the wireless receiver 440 may operate to close the valve 435, shutting off the supply of water to the leaking joint 430. It will be understood by those skilled in the art that to facilitate remote operation of the valve, the valve will be motorized or otherwise mechanized and operatively connected to an operating system for accepting and implementing instructions to facilitate remote operation.

Although the above description relates to a leaking plumbing joint, the device may be used to detect leaks at any point, whether at a joint or along a length of pipe that does not have a joint. In this manner, pipes and/or pipe sections damaged by age or other circumstance can be monitored in addition to joints.

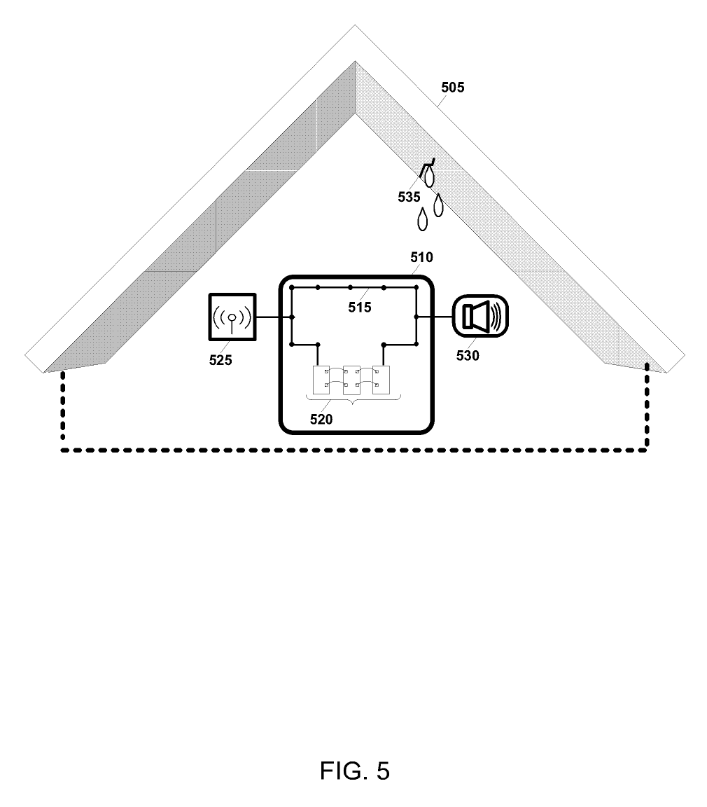

FIG. 5 depicts a still further illustrative liquid detection device according to some embodiments. As shown in FIG. 5, a liquid detection device 510 may be arranged to detect a leak 535 in a roof 505. The liquid detection device 510 may comprise a plurality of liquid-activated hydrogel batteries 520 connected in parallel. The plurality of liquid-activated hydrogel batteries 520 may be connected to a circuit 515 coupled to an alarm event detection device 530 and a wireless signal transmitter event detection device 525.

Water resulting from the leak 535 in the roof 505 may contact the liquid detection device 510. The water may enter the liquid detection device 510, hydrating the plurality of liquid-activated hydrogel batteries 520. The hydrated plurality of liquid-activated hydrogel batteries 520 may operate to generate a voltage, energizing the circuit 515. The energized circuit 515 may power the alarm device 530 and the wireless signal device 525. The alarm device 530 may operate to generate an audible alert indicating that there is a leak in the roof 505. The wireless signal device 525, for example, may send a signal to a control system for the structure (e.g., a warehouse) associated with the roof. The control system may comprise visual indicators, such as a structure control screen presented on a computing device display. The signal from the wireless signal device 525 may generate a visual indicator on the structure control screen signifying that there is a leak in the roof 505.

In the roof leak detection area, the liquid detection device can take several forms. In some instances, the liquid detect device could be embedded in or placed on the underside of the roofing shingle, roofing felt, sheathing, or even in the attic or space directly under the roof. It is contemplated, that a roofing shingle or shingle system could employ one or more such liquid detection devices, in communication with an event detection device, such that water can be detected under the shingle(s), before it can penetrate the felt or sheathing. Similarly, the roofing felt, or other such material, could contain one or more such liquid detection devices to similarly detect water passing through the shingles, before it passes through the roofing sheathing. Severe roof damage may be averted in such instances.

Although the liquid detection devices 310, 410, and 510 depicted in FIG. 3, FIG. 4, and FIG. 5, respectively, comprise one or two devices located directly adjacent to potential sources of unwanted liquid, embodiments are not so limited. For example, a structure may be configured to funnel liquids to one or more locations where a liquid detection device may be positioned to contact any funneled liquid. For instance, a roof may be associated with a sub-structure positioned below the roof to receive water leaking therefrom. The sub-structure may be designed to direct leaking water to one or more locations associated with a liquid detection device. In another example, liquid detection devices may be positioned adjacent to one or more drains located below a plumbing system. The plumbing system may be configured such that leaking water may be directed toward the one or more drains and, therefore, a liquid detection device. In a further example, multiple liquid-detection devices may be positioned strategically at sites with a higher potential for leaks and/or in areas sensitive to liquid, such as a room housing active computing devices and other electronic assets.

Some embodiments provide a liquid detection device configured to detect various human and/or animal biological fluids. Non-limiting examples of biological fluids include blood, plasma, vomit, serum, urine, sweat, saliva, perspiration and combinations thereof. In an embodiment, a liquid detection device may be arranged within a diaper to detect urine voided therein. In another embodiment, a liquid detection device may be arranged within a floor covering to detect urine voided thereon. For example, the floor covering may comprise a pet training pad.

Another beneficial application of a liquid-activated hydrogel battery configured according to some embodiments described herein is as a power supply for a perspiration-activated material. A perspiration-activated material configured according to some embodiments described herein may operate to alleviate the problems associated with perspiration on the skin by, among other things, decreasing an amount of bacteria and other microbial organisms associated with the perspiration and by decreasing the amount of perspiration that may collect on the skin.

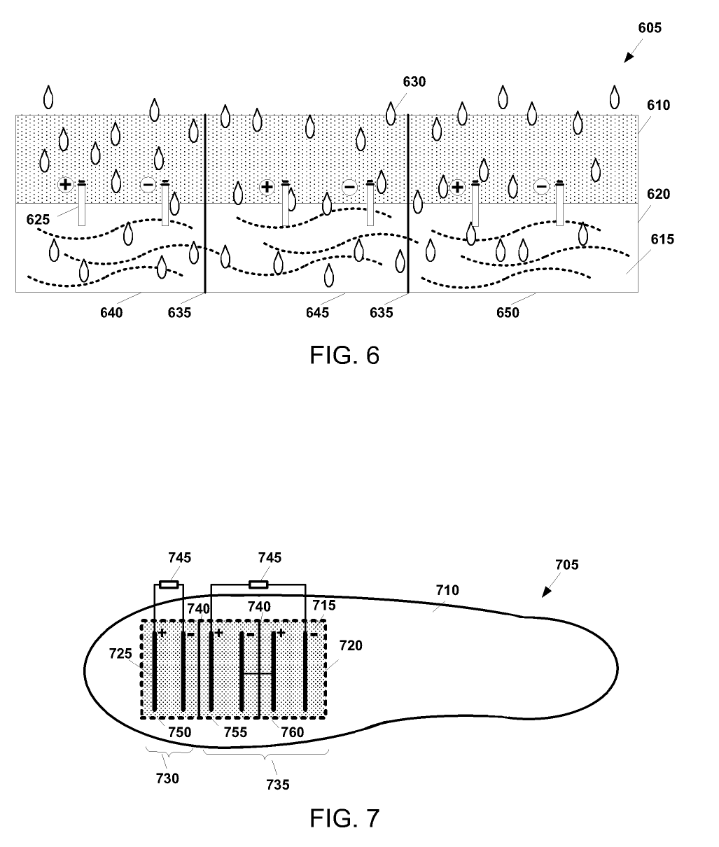

FIG. 6 depicts an illustrative perspiration-activated material according to some embodiments. As shown in FIG. 6, a perspiration-activated material 605 may include a first layer 610 comprising a conductive layer configured to receive perspiration 630. For example, the perspiration-activated material 605 may be configured as part of an item of clothing or as a footwear insert (see FIG. 7) and the first layer 610 may be in direct or indirect contact with the skin of a wearer of the clothing or shoe. In this manner, perspiration 630 from the wearer may be absorbed into the first layer 610. According to some embodiments, the first layer 610 may comprise one or more of the following conductive elements: activated carbon, metal wires, and conducting polymers. Some embodiments provide that perspiration-activated materials may be used in various other applications, including, but not limited to, being arranged within a bag or connected to sports equipment such as a shoulder pad, a thigh pad, a helmet, and a glove.

A second layer 620 is in contact or substantially in contact with the first layer 610. The second layer 620 is provided with one or more liquid-activated hydrogel batteries 615 embedded and/or dispersed therein. The liquid-activated hydrogel battery 615 may comprise hydrogel permeated with electrolyte and one or more electrodes 625 (e.g., anodes and cathodes) in contact with the hydrogel and the first layer 610. The electrodes 625 may be segmented into cathode-anode pairs by separators 635. The separators 635 may operate to segment the cathode-anode pairs into battery “cells” 640, 645, 650. According to some embodiments, the cells 640, 645, 650 may be connected in series, parallel, or combinations thereof.

According to some embodiments, the first layer 610 may be configured as a conducting layer selected and prepared to provide suitable resistance between electrodes, such as the electrodes in cells 640, 645, 650. In this manner, the first layer 610 may operate to prevent short circuits and to provide connections to connect the cells 640, 645, 650 in series, parallel, or combinations thereof. In an embodiment, the anode-cathode pairs may be connected through wires or other material having a suitable resistance, for example, provided by a resistor (not shown) (see FIG. 7).

As depicted in FIG. 6, the perspiration 630 may be absorbed into the first layer 610 and transferred to the second layer 620 such that the perspiration hydrates the hydrogel. As described herein, hydration of the hydrogel by the perspiration 630 operates to support ionic communication in the liquid-activated hydrogel battery 615, generating an electric current. The energized electrodes 625 may transfer the electric current to the first layer 610. The electric current in the first layer 610 may operate to, among other things, evaporate perspiration absorbed into the first layer and/or destroy one or more causes of perspiration odor. Illustrative causes of perspiration odor include bacteria, fungi, viruses, and other odor-causing microorganisms which may be killed by direct current. When the perspiration 630 dries such that there is an effective absence of perspiration, the liquid-activated hydrogel battery 615 is deactivated, saving energy for subsequent uses.

The first layer 610 may operate to whisk perspiration 630 from the skin and then assist in evaporating the perspiration 630 and removing odor-causing organisms. As such, the first layer 610 may comprise absorbent and/or perspiration whisking materials as known to those having ordinary skill in the art. The conductive materials of the first layer, such as activated carbon, metal wires, and conducting polymers, provide a bridge that forms a circuit with the electrodes 625 of the second layer 620. For example, in an embodiment, the first layer 610 may comprise a mesh of activated carbon that may operate as a circuit within the first layer.

The hydrogel battery 615 and the electrically active components (e.g., activated carbon) of the first layer 610 may be configured to generate current within the first layer as direct current (DC). In an embodiment, the current may be about 0.05 A. In another embodiment, the current may be about 0.5 A. In still another embodiment, the current may range from about 0.05 A to 0.1 A. In a further embodiment, the current may range from about 0.075 A to about 0.2 A. In an embodiment, the current may range from about 0.1 A to about 0.3 A. In another embodiment, the current may range from about 0.25 A to about 0.5 A. In still another embodiment, the current may range from about 0.075 A to about 0.4 A. In a further embodiment, the current may range from about 0.05 A to about 0.5 A. Specific examples of current include about 0.05 A, about 0.075 A, about 0.1 A, about 0.2 A, about 0.3 A, about 0.4 A, about 0.5 A, and ranges between any two of these values (including the endpoints). Some embodiments provide that the current may be adjusted by altering the electrical resistance of the electrically active components of the first layer 610 across the electrodes and/or by adjusting the contact area of the electrodes (e.g., the cathode).

FIG. 7 depicts another illustrative perspiration-activated material according to some embodiments. As shown in FIG. 7, a perspiration-activated footwear insert 705 may include a first layer 710 comprising a conductive layer configured to receive perspiration. The footwear insert 705 may also include a second layer 720 (viewed through a cut-out in the first layer 710, as indicated by the dashed lines) enclosing a liquid-activated hydrogel battery 715 comprising electrolyte-permeated hydrogel and multiple electrodes 725 (e.g., anodes and cathodes).

The electrodes 725 may be arranged in alternating bands configured to provide a plurality of local circuits along the longitudinal axis of the second layer 720. The electrodes 725 may be segmented into battery cells 750, 755, 760 comprising anode-cathode pairs of electrodes divided by separators 740. In an embodiment, the anode-cathode pairs may be connected through wires or other material (e.g., activated carbon) having a suitable resistance, for example, provided by a resistor 745. According to some embodiments, the cells 750, 755, 760 may be connected in series, parallel, or combinations thereof. In FIG. 7, cell 755 and cell 760 are connected in series.

According to some embodiments, the footwear insert may be used in various footwear including, without limitation, shoes, sneakers, skates, running shoes, wrestling shoes, cleats, bowling shoes, work boots, and hiking boots.

The footwear insert 705 may not receive perspiration evenly and, as such, the hydrogel of the liquid-activated hydrogel battery 715 may not be hydrated evenly. For example, hydrogel located in one area of the second layer 720 may be fully hydrated, while hydrogel located in another area of the second layer may be partially hydrated or dehydrated. As such, the local circuits defined by the placement of the electrodes 725 allow for ionic communication within a local circuit to generate a current in the area local to the local circuit. For example, the hydrogel in a first local area 730 may be hydrated such that ionic communication generates a voltage in the first local area, while the hydrogel in a second local area 735 may not be sufficiently hydrated to support ionic communication in the second local area. Although local hydrogel hydration and local circuits have been depicted and/or described as part of a perspiration-activated footwear insert, embodiments are not so limited. A local-circuit configured hydrogel battery may be used in various other applications according to some embodiments described herein, including, without limitation, as a power supply to liquid detection devices and other electronic devices.

According to some embodiments, perspiration-activated materials may be used in various applications, including, but not limited to, being arranged within a bag or connected to sports equipment such as a shoulder pad, a thigh pad, a helmet, and a glove. In an embodiment, a perspiration-activated material may be configured as a stand-alone fabric-like material that may be attached to a garment, such as the inside of a shirt, sock, or jacket, according to methods known to those having ordinary skill in the art.

Some embodiments may provide for real-time activation of the perspiration-activated materials, for example, while being worn. In some embodiments, a switch or other controller may be provided to delay activation until a desired time. For example, an athlete may not want to activate the drying effect in his or her pads or shoes while on the field of play, but could activate the drying effect after a game or practice to facilitate drying or anti-bacterial effect once the article has been removed.

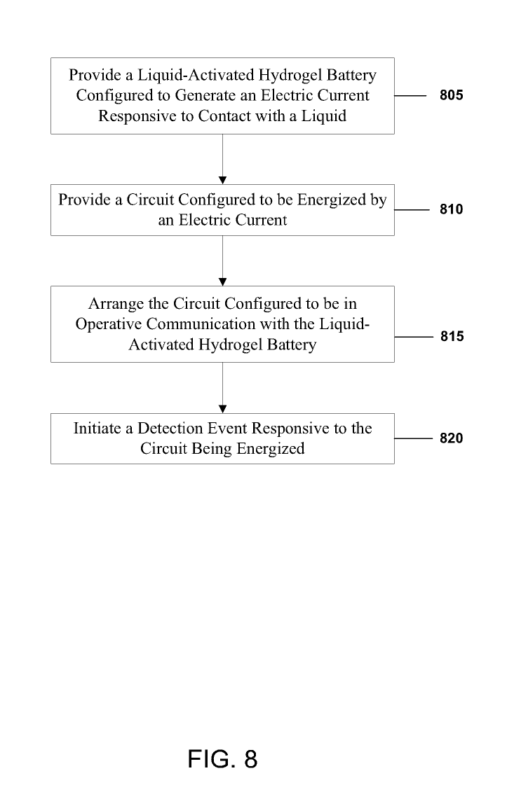

FIG. 8 depicts a flow diagram for an illustrative method of manufacturing a liquid detection device according to some embodiments. A liquid-activated hydrogel battery that is configured to generate an electric current responsive to contact with a liquid may be provided 805. For example, the liquid-activated hydrogel battery may include hydrogel comprising an electrolyte. The hydrogel may become hydrated responsive to contact with a sufficient amount of liquid, such as water, biological fluids, and/or organic solvents. An anode and a cathode may be positioned in contact with the hydrogel. For example, the anode and the cathode may be arranged within the hydrogel such that they are not in direct contact with each other. The anode and the cathode may contact the hydrogel such that they are also in contact with the electrolyte that is combined with the hydrogel.

The anode, cathode, hydrogel, and electrolyte may be arranged to form a battery circuit. The battery circuit may be configured to generate an electric current responsive to ionic communication between the anode and the cathode via the electrolyte. The anode and the cathode may be arranged to contact the hydrogel such that the ionic communication via the electrolyte is supported by the hydrogel in the hydrated state and is not supported by the hydrogel in the dehydrated state. As such, the anode and the cathode may be located in proximity to each other to facilitate the flow of ions therebetween. In addition, the anode and the cathode may be in sufficient contact with the hydrogel such that the electrolyte may promote the flow of ions between the anode and the cathode. The anode, cathode, hydrogel, and electrolyte may be arranged such that the electric current generated due to the ionic communication may be used to power an electronic device, such as a liquid detection device, or other system, such as a perspiration-activated material, connected to the battery circuit.

A circuit that is configured to be energized by an electric current may be provided 810. For example, an energy source connected to the circuit may provide an electric current operative to energize the circuit. The circuit may be configured to be in operative communication with the liquid-activated hydrogel battery 815. The electric current generated by the hydrated liquid-activated hydrogel battery may operate to energize the circuit.

A detection event may be initiated responsive to the circuit being energized 820. For example, the liquid-activated hydrogel battery may become hydrated responsive to contact with an effective amount of liquid. The hydrated liquid-activated hydrogel battery may generate an electric current that energizes the circuit. The energized circuit may provide power to an element configured to generate a detection event. For instance, the circuit may be in communication with an event detection device, such as a signal transmitter, an actuator, or an alarm device. The event detection device may initiate a detection event, such as sounding an alarm or closing a valve, or may transmit a signal to one or more elements configured to initiate a detection event.

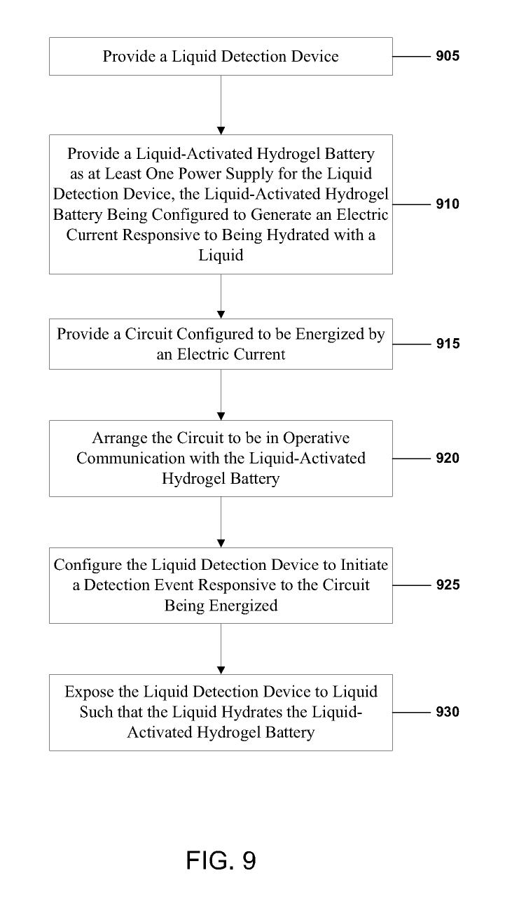

FIG. 9 depicts a flow diagram for an illustrative method of detecting a liquid using a liquid detection device according to some embodiments. A liquid detection device may be provided 905 that is configured to receive a liquid in contact therewith, for example, through one or more openings or a porous membrane. The liquid detection device may be positioned in one or more areas likely to experience unwanted liquid (e.g., plumbing system joints or areas experiencing temperature differentials) and/or in areas where electronic equipment sensitive to liquid are located.

A liquid-activated hydrogel battery may be provided as at least one power supply for the liquid detection device 910. The liquid-activated hydrogel battery may be configured to generate an electric current responsive to being hydrated with a liquid 910. As such, the liquid detection device may be in a dormant state in the absence of an effective amount of liquid and may be active in the presence of an effective amount of liquid. In this manner, a liquid detection device configured according to some embodiments described herein may conserve energy and battery life, increasing the likelihood that the battery supply will be able to power the liquid detection device when needed.

A circuit that is configured to be energized by an electric current may be provided 915. For example, an energy source connected to the circuit may provide an electric current operative to energize the circuit. The circuit may be configured to be in operative communication with the liquid-activated hydrogel battery 920. The electric current generated by the hydrated liquid-activated hydrogel battery may operate to energize the circuit.

The liquid detection device may be configured to initiate a detection event responsive to the circuit being energized 925. For example, the circuit may be in electrical communication with one or more detection event devices configured to perform a detection event. According to some embodiments, a detection event device may comprise an actuator, an alarm device, a switch, a signal transmitter, a transponder, a receiver, a transceiver, a radio-frequency identification device, and combinations thereof. As such, the one or more detection event devices may be fully or partially powered by the energized circuit to produce a detection event. For instance, a detection event device may comprise an alarm device and the detection event may comprise annunciating an alarm.

The liquid detection device may be exposed to the liquid such that the liquid hydrates the liquid-activated hydrogel battery 930. For example, the liquid detection device may be exposed to a leak in a roof or plumbing system, an influx of water due to a faulty water pump (e.g., a sump pump), or due to unintentional thawing of a liquid in a frozen environment. The liquid may hydrate the liquid-activated hydrogel battery configured to provide power to the liquid detection device. The power provided by the liquid-activated hydrogel battery, alone or in combination with one or more other batteries, may operate to energize a circuit associated with the liquid detection device in communication with a detection event device. The energized circuit may operate to power the detection event device to produce a detection event.

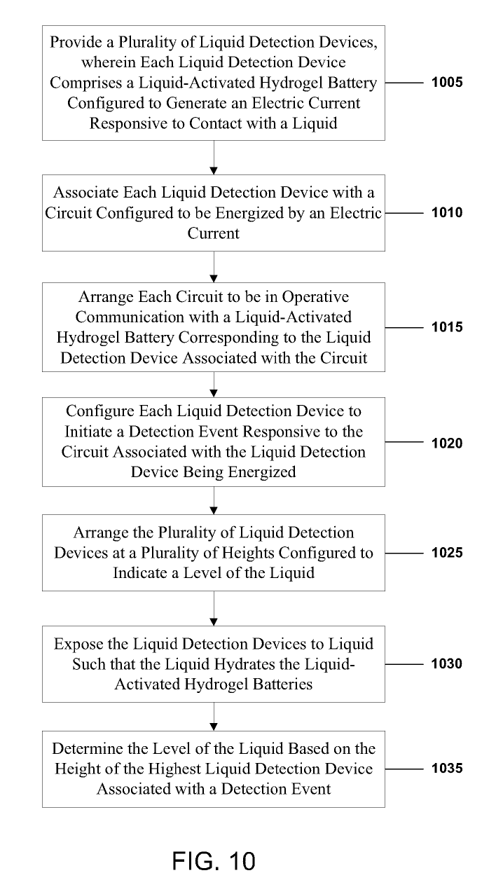

FIG. 10 depicts an illustrative method of detecting a level of a liquid using a plurality of liquid detection devices. A plurality of liquid detection devices may be provided, wherein each liquid detection device comprises a liquid-activated hydrogel battery configured to generate an electric current responsive to contact with a liquid 1005.

Each liquid detection device may be associated with a circuit that is configured to be energized by the electric current 1010. Each circuit may be configured to be in operative communication with the liquid-activated hydrogel battery corresponding to the liquid detection device associated with the circuit 1015. The electric current generated by the hydrated liquid-activated hydrogel battery may operate to energize the circuit. The energized circuit may be operative to power electronic elements connected thereto.

The liquid detection device may be configured to initiate a detection event responsive to the circuit being energized 1020. For example, the circuit may be in electrical communication with one or more detection event devices configured to perform a detection event.

The plurality of liquid detection devices may be arranged at a plurality of heights configured to indicate a level of the liquid 1025. For example, the plurality of liquid detection devices may be attached to a wall or other structure at known intervals. The length of the known intervals may depend upon the function of measuring the height of a liquid. For example, the level of water in a lake or river may be determined by arranging the plurality of liquid detection devices about every inch on a structure located in or adjacent to the water (e.g., bridge support, specific structure for measuring water level, etc.).

The liquid detection device may be exposed to the liquid such that the liquid hydrates the liquid-activated hydrogel batteries 1030. For example, the liquid-activated hydrogel batteries of the liquid detection devices at or below the level of the liquid may be hydrated and generate an electrical current. The electrical current may provide power to an detection event device operative to generate a detection event. For instance, a detection event device may comprise a light element and the detection event may comprise turning on the light associated with the light element. In another example, the detection event device may comprise a signal transmitter in communication with an electronic control system configured to present information associated with the plurality of liquid detection devices on a computing device display. The displayed information may comprise which of the plurality of liquid detection devices have been activated.

The level of the liquid may be determined based on the height of the highest liquid detection device associated with a detection event 1035. For example, ten liquid detection devices may be arranged at about one foot intervals starting from the base of a structure at the bottom of a body of water that normally experiences water levels of about four feet to about six feet. If seven of the liquid detection devices are activated as indicated by their associated detection event (e.g., lighting up, transmitting a signal to a control screen, etc.), then the level of the liquid indicated by the plurality of liquid detection devices is about seven feet.

### EXAMPLES

### Example 1

### Chemical Supply System Leak Detection Device

A liquid detection device will be manufactured that includes a membrane having pores allowing liquid to enter the liquid detection device. A liquid-activated hydrogel battery will be used as a power source for the liquid detection device. The battery components will include at least a hydrogel, an electrolyte, a cathode, and an anode.

The hydrogel and electrolyte will consist of a combination of the monomer hydroxyethyl methacrylate (HEMA), polymerization initiator 2,2′-azobis-2-methyl-propanimidamide, dihydrochloride (AAPH), and the electrolyte ammonium chloride dissolved in water. The hydrogel will consist of polyhydroxyethyl methacrylate (pHEMA) permeated with ammonium chloride electrolyte. The anode will consist of zinc and the cathode will consist of copper.

The liquid-activated hydrogel battery will be positioned such that liquid entering the liquid detection device will contact the hydrogel. The liquid-activated hydrogel battery will be inserted into the liquid detection device such that the electrode leads contact the circuit arranged within the liquid detection device. The circuit will be connected to a wireless signal transmitter configured to transmit a signal to a remote electronic alarm device having a receiver operative to receive the signal and operating using its own power supply.

The liquid detection device will be located to detect a leak in a chemical supply system designed to supply diluted acetic acid to a processing line manufacturing metal components. The acetic acid will clean the metal components during certain phases of the manufacturing process. The liquid detection device will be attached to a T-joint of the acetic acid supply system having an elevated risk of experiencing a leak. The liquid detection device will be positioned such that acetic acid leaking from the T-joint will contact the liquid detection device. The electronic alarm device will be arranged to indicate the location of the liquid detection device experiencing a detection event.

The T-joint may develop a leak. If this occurs, the acetic acid leaking from the T-joint will contact the liquid detection device, enter the membrane, and hydrate the hydrogel of the liquid-activated hydrogel battery. The hydrated hydrogel will support ionic communication between the anode and the cathode that will generate an electric current. The circuit arranged within the liquid detection device will be energized by the electric current and will power the wireless signal transmitter. The energized wireless signal transmitter will transmit a signal to the remote alarm device. The signal will trigger the alarm device to sound an alarm alerting personnel at the facility manufacturing the metal components that there is a leak in the T-joint.

The personnel at the facility manufacturing the metal components will stop the leak and the liquid-activated hydrogel battery will dehydrate such that ionic communication will no longer be supported by the hydrogel. The liquid-activated hydrogel battery will not generate a current. The circuit will become de-energized and the liquid detection device will enter a dormant state.

### Example 2

### Ceiling Leak Detection System

A liquid detection device will be manufactured that is a 15 cm×15 cm tile with an outer plastic surface. The liquid detection device will have a concave upper surface that will funnel water to a centrally located opening. Water contacting the upper surface will enter the liquid detection device through the opening. Six liquid-activated hydrogel batteries connected in series will be located inside the liquid detection device as a power supply. The liquid-activated batteries will be connected to a circuit within the liquid detection device. The circuit will be connected to an electronic alarm device and a light emitting diode (LED) light element. A plurality of liquid detection devices will be arranged as a tiled ceiling structure for a room housing sensitive electronic equipment.

A roof leak may develop above the tiled ceiling structure. If this occurs, water from the leak will land on the tiled ceiling structure and will enter the leak detection devices that come in contact with the water through their respective openings. The water will hydrate the hydrogels of the liquid-activated batteries of the liquid detection devices contacting the water. The hydrated hydrogels will support ionic communication and each series of liquid-activated hydrogel batteries will generate a voltage of about 5.0 V for their respective liquid detection devices. The voltage will energize the circuit and provide power to the electronic alarm device and the LED light for each liquid detection device contacting the water. The electronic alarm device will generate an alarm indicating that water is contacting the ceiling and the LED lights will light up, indicating which tiles are in contact with the water.

### Example 3

### Home Plumbing Leak Detection

A first and second liquid detection device will be manufactured that include a semi-permeable membrane allowing liquid and liquid vapor to enter the liquid detection device. For the first liquid detection device, three liquid-activated hydrogel batteries will be connected in series and will be used as a power source. The second liquid detection device will use one liquid-activated hydrogel battery as a power source. The liquid-activated hydrogel batteries in both the first liquid detection device and the second liquid detection device will be connected to a circuit within each liquid detection device. For the first liquid detection device, the circuit will be connected to an audible alarm device. For the second liquid detection device, the circuit will operate as a switch for an audible alarm device connected to a separate conventional (e.g., non-liquid-activated hydrogel battery) power supply. Each battery will include at least one polyacrylamide hydrogel, a potassium hydroxide electrolyte, a copper cathode, and an aluminum anode.

The two liquid detection devices will be placed in a personal residence for leak detection purposes. A first liquid detection device will be placed on a surface adjacent to a hot water tank such that if the tank leaks, the leaking water will contact the first liquid detection device. A second liquid detection device will be placed adjacent to exposed water pipes such that if the pipes leak, the leaking water will contact the second liquid detection device.

The hot water tank and/or the pipes may develop a leak. If this occurs, water from the leak will land on the first and/or second leak detection device and will enter the first and/or second leak detection device through their respective semi-permeable membranes. The water will hydrate the hydrogels of the liquid-activated batteries of the first and/or second liquid detection devices contacting the water. The hydrated hydrogels will support ionic communication and each series of liquid-activated hydrogel batteries will generate a voltage of about 3.0 V for their respective first and/or second liquid detection devices. For the first liquid-detection device, the voltage will energize the circuit and provide power to the audible alarm device that will generate an alarm signaling that a leak has occurred. For the second liquid-detection device, the voltage will energize the circuit and operate as a switch connecting the audible alarm device to the conventional power supply, which will provide power to the audible alarm device that will generate an alarm signaling that a leak has occurred.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior developments. As used in this document, the term “comprising” means “including, but not limited to.”

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A liquid detection device comprising:
at least one liquid-activated hydrogel battery configured to generate an electric current responsive to contact with a liquid, the at least one liquid-activated hydrogel battery comprising:
at least one hydrogel comprising at least one hydrophilic polymer and at least one electrolyte; and
at least one anode and at least one cathode in contact with the at least one hydrogel;
wherein the at least one electrolyte supports ionic communication between the at least one anode and the at least one cathode responsive to the hydrogel being hydrated with the liquid and does not support the ionic communication responsive to the hydrogel being dehydrated by an effective absence of the liquid, the ionic communication generating an electric current for the at least one liquid-activated hydrogel battery; and
at least one circuit in operative communication with the at least one liquid-activated hydrogel battery and configured to be energized by the electric current, wherein a detection event is initiated responsive to the at least one circuit being energized.

2. The liquid detection device of claim 1, wherein the at least one circuit is in communication with at least one detection event device configured to generate the detection event.

3. The liquid detection device of claim 2, wherein the at least one detection event device comprises at least one of the following: an actuator, an alarm device, a switch, a signal transmitter, a transponder, a receiver, a transceiver, a radio-frequency identification device, and combinations thereof.

4-8. (canceled)

9. The liquid detection device of claim 1, wherein the liquid comprises water selected from ground water, industrial water effluent, drinking water, rain water, brackish water, surface water, mineral water, salt water, substantially fresh water, distilled water, deionized water, and combinations thereof.

10. The liquid detection device of claim 1, wherein the at least one hydrophilic polymer is selected from polymethacrylate, polyacrylate, polymethacrylamide, polyacrylamide, polyvinyl alcohol, polyvinyl acetate, cellulose or modified cellulose, collagen or modified collagen, polysaccharide, modified polysaccharide, polynucleotide, polyhydroxyethyl methacrylate (pHEMA), and combinations thereof.

11. The liquid detection device of claim 1, wherein the at least one anode comprises an anode material selected from zinc, magnesium, aluminum, calcium, lithium, conducting polymers, iron, nickel, metal oxides, and combinations thereof.

12. The liquid detection device of claim 1, wherein the at least one cathode comprises a cathode material selected from copper, carbon, silver, metal oxides, conducting polymers, carbon nanotubes, graphite, graphene, and combinations thereof.

13. The liquid detection device of claim 1, wherein the at least one electrolyte is selected from a salt, an acid, and a base.

14. The liquid detection device of claim 13, wherein the salt is selected from ammonium sulfate, ammonium hydrogen sulfate, ammonium nitrate, ammonium phosphate, ammonium hydrogen phosphate, ammonium dihydrogen phosphate, ammonium chloride, sodium hydrogen sulfate, potassium hydrogen sulfate, sodium dihydrogen phosphate, potassium dihydrogen phosphate, sodium phosphate, potassium phosphate, sodium carbonate, potassium carbonate, and combinations thereof.

15. The liquid detection device of claim 13, wherein the acid is selected from citric acid, glutaric acid, lactic acid, boric acid, acetic acid, propionic acid, phosphoric acid, phosphorous acid, hydrochloric acid, sulfuric acid, amino acids, sulfonic acids, and combinations thereof.

16. The liquid detection device of claim 13, wherein the base is selected from sodium hydroxide, potassium hydroxide, calcium hydroxide, lithium hydroxide, and combinations thereof.

17. (canceled)

18. The liquid detection device of claim 1, wherein the liquid comprises a biological fluid selected from blood, plasma, vomit, serum, urine, sweat, saliva, and combinations thereof.

19-28. (canceled)

29. A method of preparing a liquid detection device, the method comprising:
providing at least one liquid-activated hydrogel battery configured to generate an electric current responsive to contact with a liquid, the at least one liquid-activated hydrogel battery comprising:
at least one hydrogel comprising at least one hydrophilic polymer and at least one electrolyte; and
at least one anode and at least one cathode in contact with the at least one hydrogel;
wherein the at least one electrolyte supports ionic communication between the at least one anode and the at least one cathode responsive to the hydrogel being hydrated with the liquid and does not support the ionic communication responsive to the hydrogel being dehydrated by an effective absence of the liquid, the ionic communication generating an electric current for the at least one liquid-activated hydrogel battery; and
arranging at least one circuit in operative communication with the at least one liquid-activated hydrogel battery, the at least one circuit being configured to be energized responsive to the electric current;
wherein a detection event is initiated responsive to the at least one circuit being energized.

30. The method of claim 29, further comprising arranging the at least one liquid-activated hydrogel battery in a case configured to facilitate entry and exit of the liquid from the case.

31. The method of claim 30, wherein exit of the liquid from the case comprises evaporation of the liquid.

32. The method of claim 29, further comprising configuring the at least one circuit to be in communication with at least one detection event device configured to generate the detection event.

33. The method of claim 32, wherein the at least one detection event device comprises at least one of the following: an actuator, an alarm, a transceiver, a light emitting device, a processor, a transponder, a radio-frequency identification device, a computing device, and combinations thereof.

34-39. (canceled)

40. A method of detecting liquid using at least one liquid detection device, the method comprising:
providing the at least one liquid detection device comprising:
at least one liquid-activated hydrogel battery configured to generate an electric current responsive to contact with a liquid, the at least one liquid-activated hydrogel battery comprising:
at least one hydrogel comprising at least one hydrophilic polymer and at least one electrolyte; and
at least one anode and at least one cathode in contact with the at least one hydrogel;
wherein the at least one electrolyte supports ionic communication between the at least one anode and the at least one cathode responsive to the hydrogel being hydrated with the liquid and does not support the ionic communication responsive to the hydrogel being dehydrated by an effective absence of the liquid, the ionic communication generating an electric current for the at least one liquid-activated hydrogel battery; and
at least one circuit in operable communication with the at least one liquid-activated hydrogel battery and configured to be energized by the electric current, wherein a detection event is initiated responsive to the at least one circuit being energized; and
exposing the at least one liquid detection device to liquid such that the liquid hydrates the at least one hydrogel of the at least one liquid-activated hydrogel battery.

41. The method of claim 40, wherein the at least one circuit is in communication with at least one detection event device configured to generate the detection event.

42. The method of claim 40, further comprising positioning the at least one liquid detection device in an environment sensitive to the liquid, the environment comprising at least one of the following: an electronic device, dry goods, a wooden structure, moisture sensitive equipment, and combinations thereof.

43. The method of claim 42, wherein the electronic device comprises at least one of the following: a computing device, a computer, a tablet computing device, a telephone, a cell phone, an air conditioner, electronic laboratory equipment, and combinations thereof.

44. The method of claim 40, wherein the at least one liquid detection device is operative to detect thawing of a liquid in a frozen state.

45-48. (canceled)

49. The method of claim 40, wherein the at least one liquid detection device is operative to detect a plumbing leak.

50.-51. (canceled)

52. The method of claim 40, wherein the at least one liquid detection device is operative to detect a roof leak.

53-97. (canceled)
